(19) United States
(12) Patent Application Publication
(10) Pub. No.: US 2009/0101652 A1
(43) Pub. Date: Apr. 23, 2009

(54) Trash can liners with reminder features

(76) Inventors: Lawrence Clardy, Eagan, MN (US); Lashay Whittaker, Maplewood, MN (US); Eduardo E. Drake, Golden Valley, MN (US)

Correspondence Address: SCHWEGMAN, LUNDBERG & WOESSNER, P.A., P.O. BOX 2938, MINNEAPOLIS, MN, 55402, US

(21) Appl. No.: 11/974,710

(22) Filed: Oct. 17, 2007

(51) Int. Cl. B65D 25/14; G06Q 10/00; G06Q 30/00; B65D 25/00

(52) U.S. Cl. 220/495.07; 705/28; 705/14; 220/495.03

(57) ABSTRACT

The present inventors identified that conventional packaging of trashcan liners makes it difficult for consumers to know when their supply of trashcan liners is about to run out. Accordingly, they devised, among other things, a sequence of plastic trashcan liners within a container that includes one or more indicators that the sequence of liners is approaching its end. In some embodiments, the indicators are associated with promotional devices, such as coupons or other forms of advertising content, thereby allowing advertisers or sponsors to temporally couple an actual need of the consumer to shop at local retailer with a geographically or functionally related product promotion.

### CROSS-REFERENCE TO RELATED APPLICATIONS

The present application claims priority to U.S. Provisional Application 60/851,463 which was filed on Oct. 13, 2007.

### TECHNICAL FIELD

Various embodiments of the present invention concern trashcan liners or garbage bags.

### BACKGROUND

Trashcan liners, or garbage bags, have been available for decades. These liners are typically sold in a closed cardboard box that with an opening to allow removal of the liners sequentially one after the other.

The present inventors identified at least one problem with the conventional packaging and dispensing of trashcan liners. The problem concerns the difficulty in consumers knowing how many liners are remaining in the box after the initial liner is used. This difficulty makes the consumers vulnerable to running out of liners or leads them to purchase greater quantities of liners than may be desirable given available storage space.

Accordingly, the present inventors have identified a need to improve the dispensation of trashcan liners.

### SUMMARY

To address this and/or other needs, the present inventors devised, among other things, a sequence of trashcan liners in a container, with one or more of the liners differentiated from other liners in the container to indicate relative position in the sequence. In one embodiment, a last set of liners in the sequence, for example the last three, are different in color than a first set of liners in the sequence to indicate to a consumer that the end of the sequence is near. In some embodiments, one or more of the last set of liners may include or be associated with an advertising message or device. For example, in some instances the device is a discount coupon for the same or upgraded type of trashcan liner or for one or more other products or services. Notably, placement of the advertising message or device on one or more of the last set of liners generally results in the advertising message or device being presented to a consumer at a time when there is a known need to make a purchase at a local retailer. Presentation of message in context with the need results in a powerful form of just-in-time promotional communication.

Other embodiments of the invention include placement of advertising content on any of the liners in the sequence and/or using alternative techniques to indicate relative position. Still other embodiments treat trashcan liners as an advertising or promotional medium in residential, business, and public trashcans. Moreover, other embodiments extend the concept by enlisting waste collection businesses to distribute trash liners to their customers on a periodic basis, thereby allowing them to add value to their existing customer relationships and generate further revenues with little if any further investment in labor or capital.

### BRIEF DESCRIPTION OF THE DRAWINGS

FIG. 1 is block diagram of an exemplary trashcan liner assembly 100 which corresponds to one or more embodiments of the present invention.

FIG. 2 is a block diagram of an exemplary trashcan liner assembly 200 which corresponds to one or more embodiments of the present invention.

FIG. 3 is a block diagram of an exemplary trashcan assembly 300 which corresponds to one or more embodiments of the present invention.

### DETAILED DESCRIPTION OF EXEMPLARY EMBODIMENTS

This description and incorporated drawing describe one or more specific embodiments of at least one invention. These embodiments, offered not to limit but only to exemplify and teach, are shown and described in sufficient detail to enable those skilled in the art to implement or practice the invention. Thus, where appropriate to avoid obscuring the invention, the description may omit certain information known to or ascertainable without undue experimentation by those of skill in the art.

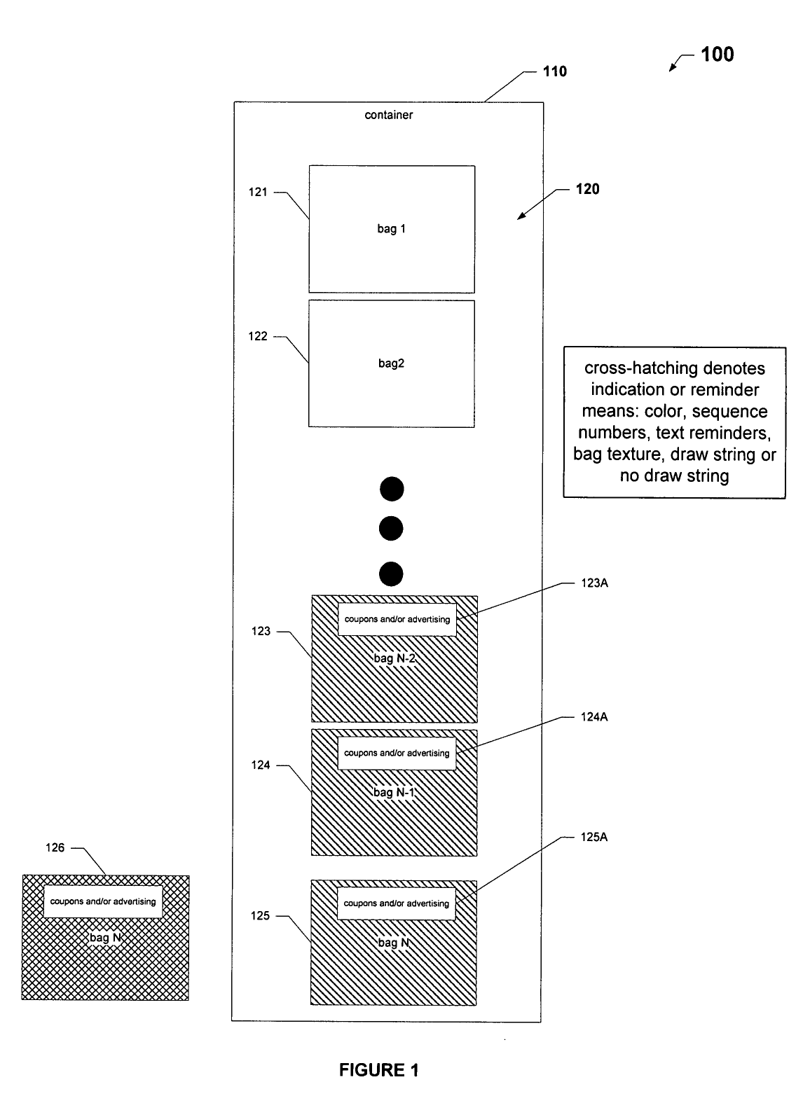

FIG. 1 is a block diagram of an exemplary trashcan liner assembly 100. Assembly 100 includes a container 110 and a trashcan liner sequence 120. Container 110 may take any desirable and convenient form. Exemplary containers include cardboard boxes. In some embodiments, container 110 can be attached to a trashcan, for example to an interior bottom surface of the can, as described in U.S. Pat. No. 5,671,847, which is incorporated herein by reference.

Trashcan liner sequence 120 includes a sequence of N trashcan liners, which are generally represented by liners 121, 122, 123, 124, 125, and 126. Liners 121, 122, and 123 are generally represented of a first set of liners in the sequence, with liner 121 arranged to be dispensed or removed from an opening (not shown) in container 110 before liner 122 and liner arranged to be removed or dispensed from container 110 before liner 123. Liners 123, 124, and 125 are generally representative of a last set of liners in sequence 120, which like liners 121, 122, and 123 are arranged for sequential dispensation or removal from container 110. In the exemplary embodiment, each of last set of liners are distinguished from the first set of liners to indicate their relative position as the last set of liners in the sequence. (In the Figure is denoted with use of cross-hatching.) In the exemplary embodiment, the indication or reminder means includes different: color, sequence numbers, text reminders, bag texture, draw string or no draw string, or different draw string color. Additionally each of the last liners, 123-126 includes respective promotional or advertising messages or device(s) 123A, 124A, 125A, 126A. In the exemplary embodiment, these messages or devices. coupons and/or advertising could be printed on bag or on substrate adhered to bag or on a part of the bag assembly, such as draw string or cinch; could also include a prepostage paid post card to collect consumer information or to request mailing of new bags. coupons could be placed on bags other than last bags. Liner 126 is further differentiated from other liners in the last set of liners to indicate that it is the last liner in the sequence. For example, last or final bag in the sequence of N bags could include further differentiation from the other “marked” bags. For example, extra markings, or darker shade of the “reminder” color, such as a sequence of two pink reminder bags followed a final red bag.

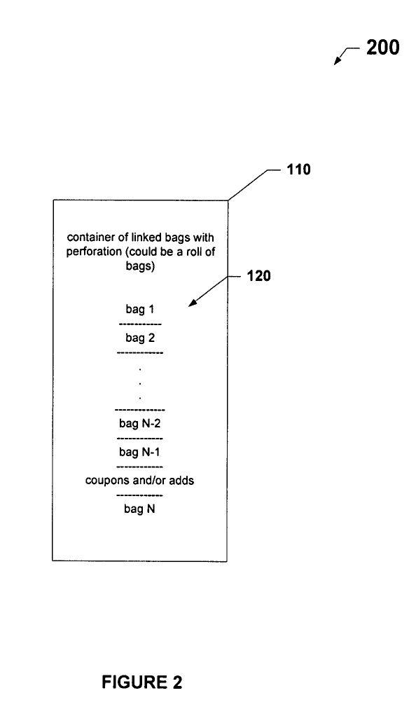

FIG. 2 is a block diagram of an exemplary trashcan liner assembly 200 which corresponds to one or more embodiments of the present invention. Assembly 200 is similar to assembly 100 with the exception that the bags are lined via perforated regions. Also, the promotional devices may be attached to separate perforated regions between the bags.

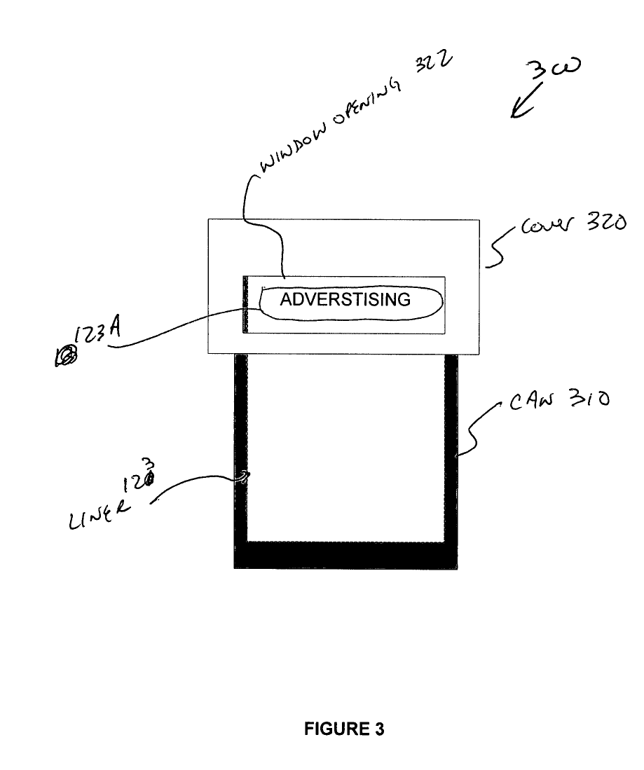

FIG. 3 is a block diagram of an exemplary trashcan assembly 300 which corresponds to one or more embodiments of the present invention. The liner includes advertising for example along an interior portion of the top edge, which folds over the exterior top portion of the receptacle when installed in a trashcan or receptable. A cover of the receptable engages the top of the receptacle, holding the bag in place. The cover has an opening exposing the advertising. In some embodiments, lighting elements in the cover, for example, along a top edge of the cover, illuminate the advertising. In other embodiments, the advertising may be formed of a glow in the dark ink or material.

What is claimed is:

1. An assembly comprising:
a container; and
a sequence of two or more plastic trashcan liners within the container; and
means, associated with the sequence, for reminding a user to purchase a new sequence of trash can liners or indicating that the.

2. The assembly of claim 1, wherein the sequence includes a first set of two or more liners formed of a first color of plastic and a last set of one or more liners that succeed the first set of liners in the sequence, with one or more of the last set of liners formed of a second color of plastic different from the first color to differentiate the last set of liners from the first set of liners and to thus remind a consumer to purchase a new sequence of trash can liners.

3. The assembly of claim 1, wherein a coupon is affixed to one or more of the last set of liners via a adhesive.

4. The assembly of claim 3, wherein the coupon is for a product other than trash can liners.

5. The assembly of claim 2, wherein one or more of the last set of liners includes a pre-addressed and pre-postage-paid postcard or toll-free telephone number or Uniform Resource Locator code for use in ordering a new sequence of liners.

6. The assembly of claim 1, wherein the sequence of trash can liners is formed from a continuous web of polyethylene, with each of the liners (or bags) linked to at least one other of the liners via a perforated region of polyethyline.

7. The assembly of any of the claims above wherein the means for reminding the user includes a scent, sequence number, text message, liner texture change, change of bag type, and/or change in cinch or draw string color or tie color.

8. The assembly of claim 1, wherein each liner in the sequence of liners is attached to at least one other liner in the sequence.

9. The assembly of claim 1, wherein each of the last set of liners includes a printed indicator of how many succeeding liners are remaining in the sequence.

10. The assembly of claim 1, wherein one or more of the liners includes a printed code for use in conjunction with an online product promotion.

11. The assembly of claim 10, wherein the printed code includes a discount code for downloadable music or other online multimedia.

12. The assembly of any of the claims above, wherein each of the liners includes an inner surface and an outer surface, and wherein the means for reminding includes printing on the outer surface.

13. The assembly of any of the claims above, wherein each of the liners includes an inner surface and an outer surface, and wherein the means for reminding includes printing on the inner surface.

14. The assembly of claim 13, wherein the inner surface of each liner includes a top inner region bounded by a top edge of the liner, and wherein the printing is on the top inner region.

15. The assembly of any of the claims above, wherein the means includes one or more strips substantially parallel with a top edge of each of the last bags.

16. A method of operating a commercial or municipal waste collection service, comprising:
providing free or discount garbage bags (trash can liners) to a plurality of customers under contract with the waste collection service.

17. The method of claim 16, wherein the free or discount garbage bags include advertising and/or coupons from one or more advertisers.

18. The method of claim 16, wherein the waste collection service receives a fee from one or more of the advertisers.

19. The method of claim 17, wherein the free or discount garbage bags are provided on a weekly or monthly basis, and wherein the advertising and/or coupons on the bags varies from week to week or from month to month.

20. The method of claim 17, wherein the free or discount garbage bags are provided on a weekly or monthly basis, and wherein the advertising and/or coupons on the bags varies from week to week or from month to month and from zip code to zip code within a service area of the waste collection service.

21. The assembly of any of the claims above wherein the term trash can liner is replaced with sandwich or food storage bags.

22. An assembly of two or more coffee filters manufactured or distributed by a first commercial entity, wherein at least one of the coffee filters includes printed advertising.

23. The assembly of claim X, wherein each of the coffee filters includes an interior and an exterior surface, and wherein the printed advertising is on the interior surface of the one of the coffee filters.

24. The assembly of claim X, wherein the printed advertising is associated with a second commercial entity different from the first commercial entity.

25. the assembly of claim X, wherein at least one or more of the coffee filters is visually distinct from the other coffee filters.

26. wherein the one or more visually distinct coffee filters is arranged in a sequence with the other coffee filters such that the visually distinct coffee filters succeed the other coffee filters in the sequence.

27. A waste receptable comprising a canister, a flexible liner, and a cover, wherein the flexible liner lines an interior region of the canister, with a portion of the liner overlapping a top exterior portion of the canister and the cover engaging the top exterior portion of the canister and contacting the liner, with cover leaving a portion of the flexible liner visible to users of the receptacle, with the exposed portion including at least one sponsored advertising message.
